(19) United States
(12) Patent Application Publication
(10) Pub. No.: US 2004/0093606 A1
(43) Pub. Date: May 13, 2004

(54) Information processing system and method for operation thereof

(76) Inventors: Adrian Ciornei, Bonn (DE); Achim Klabunde, Bonn (DE); Wolfgang Stein, Hennef (DE); Eric Truchet, Bonn (DE)

Correspondence Address: Norris McLaughlin & Marcus, 220 East 42nd Street 30th Floor, New York, NY, 10017, US

(21) Appl. No.: 10/276,987

(22) PCT Filed: May 23, 2001
(86) PCT No.: PCT/DE01/01932

(30) Foreign Application Priority Data
May 23, 2000 (DE) 100 25 050.5

(51) Int. Cl. G06F 9/44

(52) U.S. Cl. 719/315

(57) ABSTRACT

The invention relates to an information processing system and method for operation thereof, comprising: a central communication unit (ZDS) for the control and forwarding of information from a data set, at least one master information processing system, which communicates with the ZDS by means of an interface and which provides information for the ZDS on demand, at least one client information processing system, which communicates with the ZDS by means of an interface and which obtains information from the ZDS on request. Said information controlled by the ZDS is described by an object model, which comprises an conceptional object model (KOM), which describes the total data set as provided by the master and client systems and the views which are dedicated to the connected systems and describe all specific services related to the KOM, determine the elements of the data sets controlled by the ZDS, which said systems recognize.

The invention relates to an information processing system and a method for its operation according to the preamble of the independent claims.

The invention relates to the field of modeling complex systems. The starting point is an information processing system to be used for exchanging data between several technical applications. An important problem in modeling complex system is the match between the dynamic and static model views. The dynamic model view is typically represented by process models, whereas the static model view is represented by data models.

In conventional methods, the process typically proceeds as follows:

1. Modeling the processes

2. Identifying the data required for the processes

3. Combining and relating all data.

This method has a disadvantage of being quite inflexible with respect to, for example, changes in or additions to the process and data structure.

GB 2 319 863 A describes a so-called groupware system, in particular for Internet/intranet applications, with a plurality of client applications that provides corresponding views of information. The information is stored in a central object database together with the processes applicable to the objects. Also provided is a plurality of machines with mechanisms for storing and manipulating the objects stored in the database. The system can advantageously be employed in computer networks, whereby programs are downloaded from the network to the individual network computers where they are executed, such as Java programs.

It Is the object of the invention to propose an information processing system and a method for its operation, which simplifies a specification and development of the interfaces between the technical applications.

This object is solved by the features of the independent claims.

The information processing system according to the invention includes a central communication unit (ZDS) (1) for administrating and forwarding information from a data set, at least one master information processing system, which communicates with the ZDS via an interface and provides the ZDS with information upon request, at least one client information processing system, which communicates with the ZDS via an interface and receives information from the ZDS upon request, wherein the information administered by the ZDS is described by an object model that includes a conceptual object model (KOM) describing the entire data set made available by the master and client systems, as well as views associated with the connected systems and describing the corresponding specific services related to the KOM, wherein the views determine the elements of the data set administered by the ZDS that are recognized by the corresponding systems.

The invention is based on an object-oriented approach for modeling the processes. The object-oriented approach has the following features:

1. Identification of independent objects or abstract units which manifest themselves to the outside through data uniformity and a uniform behavior (object identification)

2. Definition of the data and behavior characteristics of these objects

3. Definition of processes as interaction between objects.

The object-oriented approach has the advantages that

objects that relate to real objects can be identified relatively easily (does not apply to abstract objects)

objects are typically smaller, less complex units than processes

objects have typically a longer validity than processes

different processes have a higher integration through commonly used objects.

In addition, the object-oriented approach has the advantage that it can be uniformly applied across all phases of the software development process (technical conception/analysis—DP—conception/design—implementation/realization—operation/maintenance) which is not the case for conventional processes.

Advantageous embodiments and modifications of the invention are recited in the dependent claims.

Advantageously, each master system provides to the ZDS the elements of its data set that are defined in a corresponding master view, wherein the elements of the data set for which the system has the data rights, are included in the master view of a connected master system.

Simultaneously, each client system has access via a data access service to the data defined in a corresponding client view, wherein the elements of the data set, for which the system can recall information from the ZDS, are included in the client view of a connected system.

In an advantageous embodiment of the invention, the views for the connected systems are formed from the KOM by the operations Projection and Selection.

A selection is made through the operation Projection, which elements are to be included in a view in the form of Classes, Attributes, Methods, Relationships of the KOM.

Individual objects of the classes are selected by a Selection. A Selection is only possible in a client view. Preferably, a filter rule is defined as a selection criteria for a class, with the filter rule determining which objects are included in the client view.

According to the invention, the corresponding view of the ZDS determines the elements of the KOM recognized by the connected system, wherein a view is described by:

classes with their

attributes and

methods (including interface)

selection criteria

relationships

consistency rules.

For communication with each other, at least two communication mechanisms in the form of a data access service and a message service are provided to the connected master and client systems by the ZDS, wherein all services provided by the ZDS are defined as Methods in the object model. Selection criteria can be applied to the services which impose additional limitations to the criteria defined for the classes.

The data access services are defined for both the client and master systems. The client systems define the data access services that are technically required and to be used for accessing the data defined in the client view. Data access services for the master systems can then be defined from the requirements of the client data access services.

The message services within the ZDS object model are defined both in master and client views. Changes in the data set of a master system are transmitted to the ZDS via the message service and that the ZDS provides these changes to the affected client systems.

In general, a separate class category is generated for each system connected to the ZDS. Each class category can itself contain two class categories for master and client views.

The special class category KOM is subdivided into several subcategories formed according to certain criteria.

The class categories include:

exactly those classes (with attributes and methods) and their relationships that are visible in the corresponding view (5; 6),

at least one class diagram illustrating the classes included in the view (5; 6),

for each operation, the specification of the signature of this method by identifying object structures.

The invention will be described hereinafter with reference to an embodiment illustrated in the drawings. The drawings and their description convey additional features, advantages and applications of the invention. It is shown in:

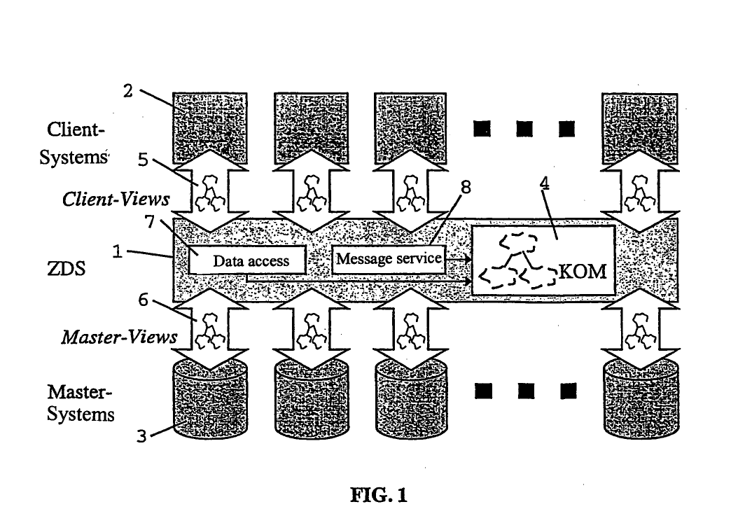

FIG. 1 a high-level diagram of an information processing system based on a ZDS;

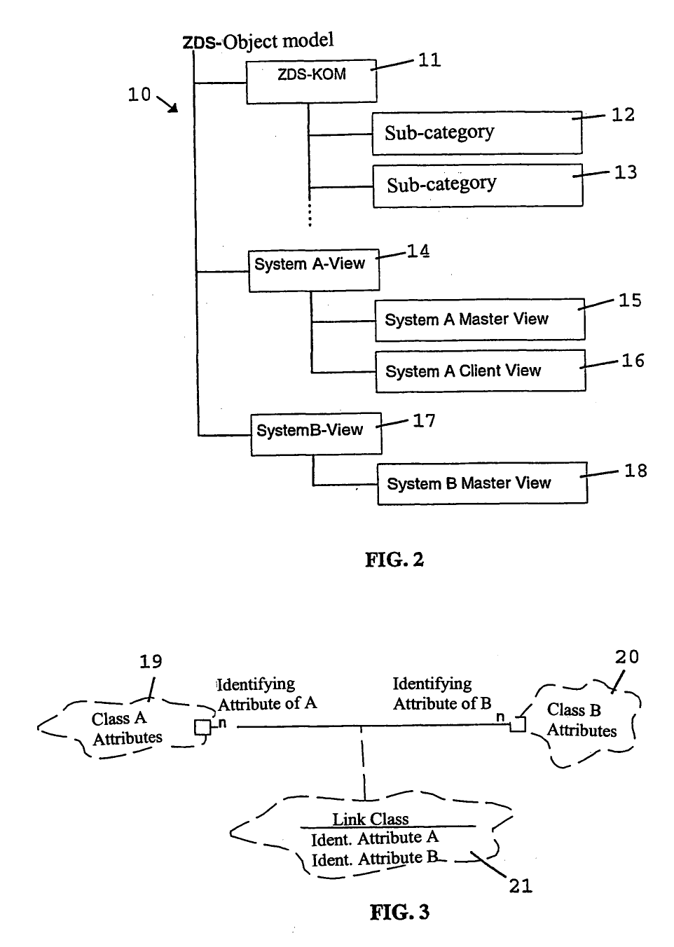

FIG. 2 a diagram depicting the hierarchy of the class categories in the ZDS object model;

FIG. 3 a definition of the interface of a view;

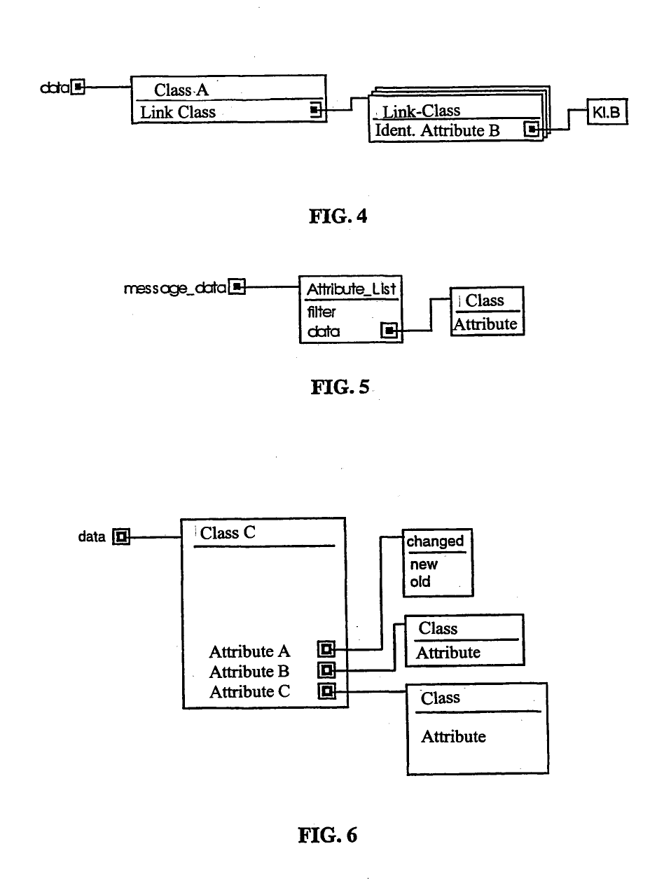

FIG. 4 a tree structure of FIG. 3;

FIG. 5 a structure of message data;

FIG. 6 a representation of an update message with old and new values.

As shown in FIG. 1, a central data server ZDS 1 is implemented as a central communication unit between technical applications represented, for example, by master systems 3 and/or client systems 2. Employing the ZDS 1 enables communication between these applications using uniform methods based on a simplified view of the data. Each application system 2; 3 requires only one interface to the ZDS 1. It is no longer necessary to develop a separate interface between each of two communicating systems. This significantly reduces the development and maintenance expense for the interfaces.

The ZDS 1 is not an application system in the typical sense. It does not perform any technical functions, nor does it offer a direct user interface or contains any technical data. Technical functions, user interfaces and technical data storage are performed in the individual applications systems 2; 3. The ZDS 1 accesses the data sets of the applications systems with a read operation and offers services that can be used by the applications systems to access the data sets of all connected applications systems recognized by the ZDS. Since many of the technical data are processed only in a specific application system, typically only a portion of the data set is made publicly available via the ZDS 1, namely the portion which is also used by the other applications systems for their tasks. The sum of all data sets accessible via the ZDS 1 is described in a common model, the conceptual object model (KOM) 4 of the ZDS 1.

The services of the ZDS 1 and the access thereto are identical for all connected systems 2; 3. However, the corresponding specific services are described for each system in a separate view on the conceptual object model 4 of the ZDS 1. This specific view has to be recognized by the system and the ZDS 1 and is defined separately for each system. Each connected systems can have two roles with respect to the ZDS 1: as a master system 3 and/or as a client system 2.

A master system 3 provides to the ZDS 1 the portion of its data set that is defined in the respective master view 6. The master systems 3 also inform the ZDS 1 about changes in their own data set. A client system 2 takes advantage of the possibilities provided by the ZDS 1 for accessing the data defined in a client view 5. Messages about changed data in the data set included in the client view 5 can be downloaded by the client system 2 from the ZDS 1.

When the master view 6 and client view 5 are decoupled, certain changes in the master views 6 do not affect the client views 5. This is particularly the case if the responsibility for a data set is handed from one master system 3 to another. Two communication mechanisms are provided by the ZDS 1 to the connected master systems 3 and client systems 2:

Data Access and Messages.

The Data Access service of the ZDS 1 gives the client systems 2 access to the data sets defined in the ZDS 1. The resulting access to the master systems 3 that are responsible for the desired data is transparent to the client systems 2, i.e., the client systems 2 do not know which master systems 3 the requested data belong to.

The message service transmits changes in the data sets of a master system 3 to the ZDS 1. The ZDS 1 then provides these changes to the affected client systems 2.

The following table shows the information included in the master and client views for Data Access and Message service:

TABLE 1
contents of the views on the ZDS

| | Data Access Service | Message Service |
|---|---|---|
| Client | which data can the | in which messages regarding |
| view | client system request | changes in the data set |
| | | is the client system |
| | | interested |
| Master | for which data has the master | with changes of the data |
| view | system the data rights | sets are transmitted to |
| | | the ZDS |

Several of the terms used in the context of object orientation will now be explained:

### Association

An association is the most common form of a relationship between classes. It describes semantic and structure of a set of object relations.

The cardinality of the association determines how many objects of the related classes are part of an association.

The semantic of the relationship is described by providing role names, i.e., the role in which objects of one class view the objects of the other class. If an association has its own attributes, then this is an attributized association.

### Attribute

An attribute is a data element that is included in each object of a class and can have a separate value in each object.

An attribute is described by its name and its type.

Identifying attributes are distinguished in that they uniquely determine an object, i.e., there is no other object with the same identifying attributes.

### Aggregation

The aggregation is a particular form of the more general association relationship. The participating classes describe a total/partial hierarchy, i.e., an aggregation describes how a total entity is composed of its parts.

### Class

A class is a set of objects that have a common structure and a common behavior. The structure of a class is described by the attributes and relationships to other classes, the behavior by the operations of a class.

### Class Category

Class categories are used to subdivide the logical model. A class category can contain classes and other class categories. Unlike a class, however, a class category does not include operations or states of the model.

### Link

A link is a concrete relationship between objects. It is an instance of an association.

### Object

An object is a concrete unit, it has its state, a behavior and an identity. Each object is an instance of a class. The information of an object is represented by attributes, whose structure is defined in the class. The behavior is determined by the operations defined in the class and is identical for all objects of a class.

### Inheritance

The inheritance is a relationship between classes, wherein one class (subclass) is part of the structure and the behavior of the other class (superclass). The subclass is a special type of the superclass.

FIG. 2 shows the configuration of the ZDS object model 10 and the rules for forming the views 5, 6 of the connected systems 2; 3.

The ZDS object model 10 is composed of the conceptual object model (KOM) 4 and is the views 5, 6 of the connected systems. For this reason, the entire model is subdivided into several categories, wherein a separate category 11, 14, 17 is provided for each system connected to the ZDS 1.

There exists a category ZDS-KOM 11 that includes KOM 4. KOM 4 in turn is arranged in several subcategories 12, 13 formed according to technical criteria. The connected systems, e.g., system A and system B, each form a corresponding category 14, 17, wherein the name of the category which includes the view of the connected system on the ZDS 1 is assigned, for example, the postfix “View” (e.g., system A-view).

Each connected system can appear to the ZDS 1 as a master system 3 and/or a client system 2. For this reason, the subcategories master view 15 and 18, respectively, and client view 16 are established in the categories 14, 17 depending on the role of the system.

As a result, the hierarchy of class categories depicted in FIG. 2 is obtained, for example, for the ZDS object model 10 with the connected systems “System A” 14 and “System B” 17.

The view 5, 6 on the ZDS 1 determines the elements of KOM 4, which the connected system recognizes. The view is described by the included

classes with their

attributes and

methods (including interface)

selection criteria

relationships

consistency rules

The master view 6 of a connected system contains the elements for which the system is the “Master”, i.e., for which the system has in the data rights. A primary master system is hereby defined for each class. This master system is responsible for the identifying attributes of the class, but in many other cases also for other attributes. However, if additional systems are responsible for other attributes, then these systems are referred to as secondary master system. In the master views of the secondary master systems, the identifying attributes of the class are included in addition to their “own” attributes.

The client view 5 of a connected system includes the elements for which the system should be able to obtain information from the ZDS.

The views 5, 6 for the connected systems cannot be formed arbitrarily from the KOM 4. Allowed operations are Projection and Selection. Other operations, aside from Selection and Projection, are not possible! For example, there is no operation Join, through which several classes of the KOM 4 could be mapped on one class of a ZDS client view 5.

The elements (classes, attributes, methods, relationships) of the KOM 4 to be included in a view 5, 6 are selected via a Projection. All other elements of the KOM 4 are disregarded by the Projection.

A Selection is only possible in a client view 5. Individual objects of the class can be selected by a Selection. For example, a section criteria for a class can be a filter rule that determines which objects are included in the client view 5.

The filter rules are defined in the classes of the client view 5. They are expressed, for example, in a syntax similar to the SQL language.

Attributes required for processing filter rules are referred to as Filter Attributes.

Consistency in the ZDS 1 is governed by the following definitions:

The ZDS 1 assumes that the data within the master system 3 are consistent at each point in time,

Consistency conditions exceeding the boundaries of the master system have to be specified,

Attributes required for evaluating the consistency conditions must be included in KOM 4,

Consistency conditions can be defined in client views 5,

The consistency of the data must not be diminished by forwarding data by the ZDS 1.

Consistency rules (as opposed to filter rules) are defined based on a client view 5, i.e., this corresponds to the logical definition that a client view 5 has to be internally consistent.

If no consistency rules are defined on the client views 5, then it is assumed that the corresponding data always mutually consistent.

Attributes required for evaluating consistency rules are referred to as Consistency Attributes.

The syntax of the consistency rules corresponds to the syntax of the filter rules.

As described above, a separate class category is modeled for each system connected to the ZDS 1, which itself can contain two class categories for the master view 6 and client view 5.

These categories include:

exactly those classes (with attributes and methods) and their relationships that are visible in the corresponding view, whereby the class names of formed according to the aforementioned naming conventions,

at least one class diagram depicting the classes that are included in the view,

for each operation, the specification of the signature of this method by specifying object structures.

Mapping this information on the ZDS object model 10 makes it possible to form a complete documentation of the object model which represents the functional part of the technical concept. It is also possible to establish with this information configuration files which can be used in the ZDS application for mapping KOM 4 on the different views 5, 6.

The following sections describe how the two rules for forming the views 5, 6 (Projection and Selection) and the specification of the interface are mapped by operations in the ZDS object model 10.

Classes and relationships are projected in that only the classes and relationships that belong to the view are included in the class categories of the views 5, 6.

These classes include only the attributes and operations that belong to the view. Moreover, the attributes in the classes of the views have the same name and type as the attributes of the corresponding classes of the KOM 4. The same applies to operations where the name and the interface should be identical.

View-specific descriptions of the elements included in the view can be displayed in the field “Documentation” of the corresponding specification dialog.

The selection, i.e., an additional filtering, cannot be expressed in the Booch notation. The section criteria with the property “Selection Criteria” of the class belonging to the view are therefore indicated in the Rose model

Consistency rules are defined based on a client view 5. The consistency rules in the Rose model are therefore indicated in the property “Consistency Rules” of the client view category.

The ZDS 1 provides different types of services:

Retrieve services for using the data access service

Message services for using the message service

All services are generally mapped as methods in the object model 10. No Call Parameters are defined for these methods, because they are defined by existing C-API functions.

Selection criteria can also be indicated for services. These limit further the criteria defined for the classes. They are defined in the property “Selection Criteria” of the corresponding method. To satisfy the existing rules for forming client and master views 5, 6, the methods have to be modeled according to the classes also in the KOM 4.

Complex tree structures are transferred at the interface for both types of services. The configuration of the tree structures has to be specifically defined for each service for generating the technical concept.

These data structures must be mappable on the corresponding views, i.e.

Only known classes, attributes and relationships can be used

References to sub-objects can be formed from associations, wherein the name of the reference corresponds to the role name of the association

The cardinality of a relationship determines if this is a single object (cardinality ←1) or a list of objects (cardinality >1).

An exception exists:

If it is certain that by evaluating selection criteria for a relationship with the cardinality >1 exactly one object is supplied, then this can be represented in the data structure by indicating a single object.

Attributized associations existing in the view are resolved, as indicated in FIG. 3 by using the Booch notation.

The corresponding tree structure is shown in FIG. 4. It is possible to navigate from class A 19 via the class name of the link class 21 to the link class, wherein the cardinality of the relationship on the side of the class B determines if one of several objects exist of the link class. It is then possible to navigate to the class B 20 from the link class via the role name (identifying attribute B) (FIG. 3).

Data access services (retrieve services) are defined for the client systems 2 and master systems 3. Client systems 2 define the necessary retrieve services that allows them access to the data defined in the client view 5.

Retrieve services for the master systems 3 are defined based on the requirements of the client retrieve services. These use the data access service for identifying the data that are requested by the client systems 2. Retrieve services are modeled in the object model as class methods of the corresponding class.

Message services are defined within the ZDS object model 10 both in the master views 6 and in the client views 5. Messages that the master system 3 transmits to the ZDS 1 are defined in a master view 6. Messages that the ZDS 1 transmits to the client system 2 are defined in a client view 5.

A message is defined as a method of the respective class.

Client systems receive only messages that are of interest to them, i.e. messages that affect the data set of the corresponding client. The selection criteria has to be taken into account during processing.

A message includes the following information:

a unique message ID,

information of the client view 5 for which the message is intended (argument “userview”),

a message type (argument “message”),

the time when the data included in the message are valid,

an indication from which master system 3 the message was transmitted, and

the message data (in the form of a ZDS_OEDATA data structure)

message types.

The following types of messages exists:

New: similar to a constructor method of the class

Update: similar to a “normal” method of a class

Delete: similar to a destructor method of a class

FIG. 5 illustrates the basic structure of the message data. When a message is processed in the CM component, the message data have to be read therein. A maximum of two entries exists in the data structure (function parameter “message_data”):

a Boolean value “filter” and

a ZDS_OEDATA structure “data”

The value “filter” exists in each update message transmitted to a client system 2 and contains the value determined during evaluation of the filter rule. If no filter rule is defined for the client 2, then the value TRUE is entered. The result of the filter rule is required for dealing with update messages on the client side.

The substructure “data” is contained in each message, i.e., both in the messages for the client systems 2 and also in the messages sent by the master systems 3 to the ZDS 1. The configuration of the substructure depends on the respective specification of the message.

The configuration of “data” in the client system 2 corresponds exactly to those elements that the client system 2 wishes to receive. The configuration of the corresponding message in the master system 3 depends on the requirements of the different client systems 2 for a certain message type of a class: it's “data” structure has to be defined so that it includes all information of this master that are associated with this message.

The contents of the substructure “data” depends on the message type:

message type New: “data” contains the data of the new object.

message type Update: “data” contains the new data of the object.

message type Delete: “data” contains the data of the object to be deleted.

When specifying an update message in a master view 6, it can be additionally indicated if the old values also to be supplied. This information is displayed in the master view 6 in the ZDS property “Message Data Master” of the corresponding method.

When specifying an update message in a client view 5, it can also be indicated

if the client system 2 wishes to receive also the old values, and

if the client system 2 is interested in all values or only in the changed values.

This information is displayed in the client view 5 in the ZDS property “Message Data Client” of the corresponding method.

As illustrated in FIG. 6, old values are displayed in update messages, if present, as follows: the data structure includes instead of the actual attribute value an object of the class “changed”. This object has the attributes “new” and “old” representing the new and old attribute values, respectively.

The class “changed” is defined particularly for this purpose. Although this class is not used in the definition of the message data structure, it exists in the data structure if the old values are to be supplied.

The example of FIG. 6 shows the data structure for the situation where the attribute A of the class C has been changed.

### List of Reference Numerals

1 central data server ( ZDS)

2 client system

3 master system

4 conceptional object model (KOM)

5 client view

6 master view

7 data access

8 message service

10 ZDS object model

11 category (ZDS.-KOM)

12 subcategory

13 subcategory

14 category (view)

15 subcategory (master view)

16 subcategory (client view)

17 category (view)

18 subcategory (master view)

19 class

20 class

21 link class

1. Information processing system comprising
a central communication unit ZDS (1) for administration and forwarding of information from a data set,
at least one master information processing system (3), which communicates with the ZDS (1) via an interface and provides the ZDS (1) with information upon request,
at least one client information processing system (2), which communicates with the ZDS (1) via an interface and receives information from the ZDS (1) upon request,
wherein the information administered by the ZDS (1) is described by an object model (10) that includes a conceptual object model KOM (4) describing the entire data set made available by the master and client systems (2; 3), as well as views (5; 6) associated with the connected systems and describing the corresponding specific services related to the KOM (4), with the views determining the elements of the data set administered by the ZDS (1) that are recognized by the corresponding systems (2; 3).

2. Information processing system according to claim 1, characterized in that each master system (3) provides to the ZDS (1) the elements of its data set that are defined in a corresponding master view (6).

3. Information processing system according to one of the claims 1 or 2, characterized in that the elements of the data set for which the system has the data rights, are included in the master view (6) of a connected master system (3).

4. Information processing system according to one or more of the preceding claims, characterized in that each client system (2) has access via a data access service to the data defined in a corresponding client view (5).

5. Information processing system according to one or more of the preceding claims, characterized in that the elements of the data set, for which the system can recall information from the ZDS (1), are included in the client view (5) of a connected system (2).

6. Information processing system according to one or more of the preceding claims, characterized in that the views (5; 6) for the connected systems are formed from the KOM (4) by the operations Projection and Selection.

7. Information processing system according to one or more of the preceding claims, characterized in that a selection is made through the operation Projection, which elements are to be included in a view (5; 6) in the form of classes, attributes, methods, relationships of the KOM (4).

8. Information processing system according to one or more of the preceding claims, characterized in that individual objects of the classes are selected by a Selection.

9. Information processing system according to one or more of the preceding claims, characterized in that a Selection is only possible in a client view (5).

10. Information processing system according to one or more of the preceding claims, characterized in that a filter rule is defined as a selection criteria for a class, with the filter rule determining which objects are included in the client view (5).

11. Information processing system according to one or more of the preceding claims, characterized in that the corresponding view (5; 6) of the ZDS (1) determines the elements of the KOM (4) recognized by the connected system (2; 3), wherein a view (5; 6) is described by:
classes with their
attributes and
methods (including interface)
selection criteria
relationships
consistency rules.

12. Information processing system according to one or more of the preceding claims, characterized in that at least two communication mechanisms in the form of a data access service and a message service are provided to the connected master and client systems (2; 3) by the ZDS (1).

13. Information processing system according to one or more of the preceding claims, characterized in that all services provided by the ZDS (1) are defined as Methods in the object model.

14. Information processing system according to one or more of the preceding claims, characterized in that selection criteria are applied to the services which impose additional limitations to the criteria defined for the classes.

15. Information processing system according to one or more of the preceding claims, characterized in that data access services are defined for client and master systems (2; 3).

16. Information processing system according to one or more of the preceding claims, characterized in that client systems (2) define the data access services that are technically required and to be used for accessing the data defined in the client view (5).

17. Information processing system according to one or more of the preceding claims, characterized in that data access services for the master systems (3) are defined from the requirements of the client data access services.

18. Information processing system according to one or more of the preceding claims, characterized in that changes in the data set of a master system (3) are transmitted to the ZDS (1) via the message service and that the ZDS (1) provides these changes to the affected client systems (2).

19. Information processing system according to one or more of the preceding claims, characterized in that the message services are defined within the ZDS object model (10) both in master and client views (5; 6).

20. Information processing system according to one or more of the preceding claims, characterized in that a separate class category is generated for each system (2; 3) connected to the ZDS (1).

21. Information processing system according to one or more of the preceding claims, characterized in that each class category can itself contain two class categories for master and client views (5; 6).

22. Information processing system according to one or more of the preceding claims, characterized in that the class category KOM (11) is subdivided into several subcategories (12; 13) formed according to certain criteria.

23. Information processing system according to one or more of the preceding claims, characterized in that the class categories include:
exactly those classes (with attributes and methods) and their relationships that are visible in the corresponding view (5; 6),
at least one class diagram illustrating the classes included in the view (5; 6),
for each operation, the specification of the signature of this method by identifying object structures.

24. Method for operating an information processing system, characterized by:
providing a central communication unit ZDS (1) for administrating and forwarding information of a data set,
providing at least one master information processing system (3), which communicates with the ZDS (1) via an interface and provides to the ZDS (1) information upon request,
providing at least one client information processing system (2), which communicates with the ZDS (1) via an interface and receives from the ZDS (1) information upon request,
wherein the information administered by the ZDS (1) is structured as an object model (10) that includes a conceptual object model KOM (4) describing the entire data set made available by the master and client systems (2; 3), as well as views (5; 6) associated with the connected systems and describing the corresponding specific services related to the KOM (4), with the views determining the elements of the data set administered by the ZDS (1) that are recognized by the corresponding systems (2; 3).
